(19) United States
(12) Patent Application Publication
(10) Pub. No.: US 2004/0262268 A1
(43) Pub. Date: Dec. 30, 2004

(54) Plasma burner with microwave stimulation

(76) Inventor: Jeng-Ming Wu, Magdeburg (DE)

Correspondence Address: Law Offices of Karl Hormann, PO Box 381516, Cambridge, MA, 02238-1516, US

(21) Appl. No.: 10/488,316

(22) PCT Filed: Aug. 20, 2002
(86) PCT No.: PCT/DE02/03102

(30) Foreign Application Priority Data
Aug. 28, 2001 (DE) 101 43 114.7

(51) Int. Cl. B23K 10/00

(52) U.S. Cl. 219/121.36

(57) ABSTRACT

A plasma burner with microwave stimulation having a cavity of enlarged diameter in the region of the plasma and electrically-conductive windings coaxially encompassing the plasma within the cavity. Said winding render the electrical waveguide system formed by the cavity and windings as coaxial outer guide and the plasma as coaxial inner guide suitable for the transmission of microwaves in said region of the plasma burner in respect of impedance and transmission bandwidth in a particular manner, even with significant pressure variations of the process gas and corresponding variable conductance conditions.

### BACKGROUND OF THE INVENTION

1. Field of the Invention

The invention relates to a plasma burner with microwave stimulation, in which a plasma is generated by microwaves acting with a gas.

2. The Prior Art

A plasma burner with a microwave generator is known from German patent specification 195 11 915 A1. It is provided with a waveguide for conducting microwaves generated by a microwave generator and with a hollow metallic tube branching off from the waveguide. An electrically conductive elongate nozzle is arranged in the interior center of the hollow tube and extends from the waveguide into the hollow metallic tube and at the end extending into the hollow metallic tube is provided with a nozzle tip. At the level of the flame, preferably beginning in the area of the nozzle tip, the diameter of the hollow tube is enlarged. In the direction of the plasma burner the section of enlarged diameter extends at least beyond the area of the flame. The purpose of the enlarged diameter is to ensure that the conditions for the propagation of microwaves are satisfied even in the area of the flame so that a stable plasma may be generated. The process gas for generating the plasma is fed through the nozzle to the area of high microwave power density at the tip of the nozzle. However, the improved plasma stability attained by the improved conditions of propagation of the microwaves in the area of the flame has in practice been found to be insufficient, particularly in case of significant changes of the process gas pressure. Constant adjustments of the microwave impedance of the waveguide as well as of the hollow metallic tube undertaken in practice did neither lead to a satisfactory stabilization of the plasma at process gas pressure fluctuations nor, more particularly, to a stable ignition or re-ignition of the plasma.

### OBJECT OF THE INVENTION

It is thus an object of the invention to provide a plasma burner with microwave stimulation which even at large fluctuations of the process gas pressure ensures sufficiently good conditions of microwave propagation for a stable plasma and which ensures stable ignition or re-ignition of the plasma without any need for constantly adjusting the microwave impedance of the waveguide as well as of the hollow metallic tube.

### BRIEF SUMMERY OF THE INVENTION

In accordance with the invention, the object is accomplished by a plasma burner having the characteristics of the first patent claim. The ensuing claims 2 through 4 relate to useful embodiments of the solution in accordance with the invention.

It has been found that electrically conductive coils axially spaced from each other and arranged within the cavity formed by the enlargement of the diameter in accordance with German patent specification 195 11 915 and coaxially circumscribing the plasma significantly improve the conditions of microwave propagation, so that the stability of the plasma is ensured even at significant pressure fluctuation of the injected process gas. The transmission bandwidth of the microwave propagation system formed by the hollow metallic tube as the external conductor and the plasma as the coaxial internal conductor is markedly increased by the electrically conductive coils. Good microwave propagation is thus possible in the area of the hollow metallic tube, even at changing conditions of propagation as a result of fluctuations of the process gas pressure, without requiring constant adjustments of the microwave impedance of the waveguide or of the hollow metallic tube. The invention is based upon the realization that unlike heretofore assumed, as a coaxial internal conductor, in respect of its electric properties plasma because of its free electrons, acts like a metallic conductor, but, rather, that the electric properties of the plasma depend significantly upon the pressure of the injected process gas.

Tests have shown that in terms of the desired effect of increasing the transmission bandwidth of the microwave propagation system constituted by the hollow tube and the plasma, it is of no consequence whether the electrically conductive coils in accordance with the invention are structured as a single layer cylindrical coil or as individual conductor loops. It has been found that it is equally without consequence whether the inventive electrically conductive coils are arranged free of potential or whether they are connected to the hollow metallic tube. The number of, and spaces between, the coils may vary without yielding a noticeably reduced effect. Preferably, however, the coils should occupy the cavity formed by the increase in diameter over its longitudinal extent with individual coils being sufficiently separated from each other, i.e. at least by the thickness of the used conductive material. For a continuous operation of the plasma burner it would be efficacious to provide for cooling of the coils, e.g. by using a tubular conductive material.

It has also been found to be efficacious, to branch off another hollow tube section from the waveguide at a position opposite the hollow metallic tube and to extend the internal conductor which terminates in the area of the increased diameter through the waveguide into the opposite further hollow metallic tube section. The volumes of the two hollow tube sections should be connected to each other by a non-conductive tubular element extending through, and sealed from, the waveguide to prevent process gas introduced in this opposite hollow tube section does not flow into the waveguide but into the hollow tube provided with the increased diameter section. It is, of course, also possible to provide a non-conductive tubular element which permeates both hollow tube sections or even the entire plasma burner, for conducing the process gas. The internal conductor which terminates in the area of the enlarged diameter would then be arranged within this non-conductive tubular element so that the plasma is generated within this non-conductive tubular element. As regards the stability of the plasma, it is important, as was also established on the basis of tests, that the process gas is introduced such that at the end of the internal conductor in the area of the enlarged diameter the process gas flows with low intensity turbulence. The low intensity turbulence is especially significant for an assured ignition or re-ignition of the plasma. This is accomplished, for instance, by introducing the process gas as far as possible from the enlarged diameter and, hence, from the end of the coaxial internal conductor.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 is a principle representation of a plasma burner in accordance with the invention; and

FIG. 2 is a modification of the plasma burner shown in FIG. 1.

### DETAILED DESCRIPTION OF THE PREFERRED EMBODIMENTS

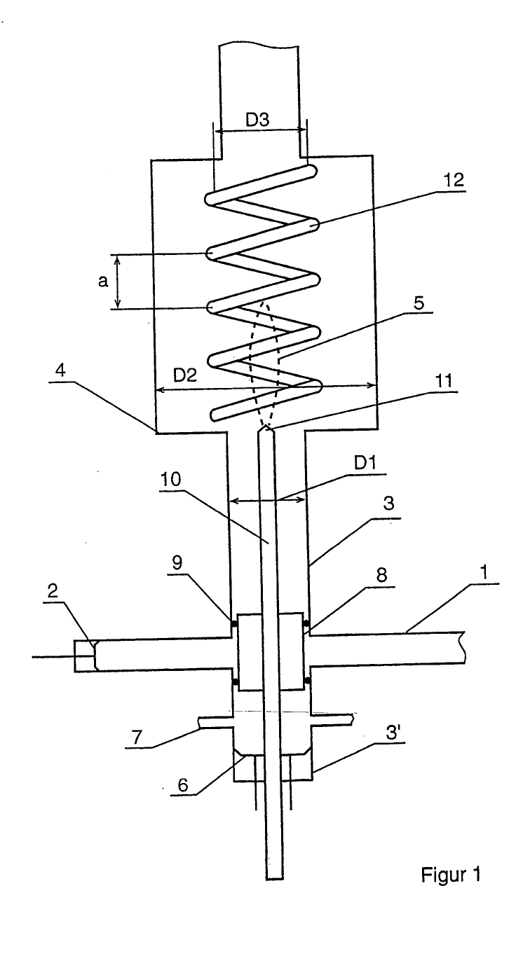

A shown in FIG. 1, the plasma burner in accordance with the invention is provided with a rectangular wave guide 1 for feeding microwaves generated by a microwave generator (not shown) to the plasma burner. At its end the rectangular waveguide 1 is provided with a short circuit 2 for adjustment of the impedance to different applications. At one side of the rectangular waveguide 1 there is connected a hollow metallic tube 3 having a diameter D1 and which is provided with a section 4 of enlarged diameter D2 which extends at least over the area of the plasma 5. At the opposite side of the rectangular waveguide 1 there is provided, as an axial extension of the hollow tube 3, a hollow tubular section 3′ of diameter D1 which is closed by an adjustable short circuit 6 for changing the impedance of the hollow tube 3, 3′. Two gas fee connections 7 are arranged at the hollow tube section 3′. The volumes of the hollow tube 3 and of the hollow tube section 3′ are connected to each other by an electrically non-conductive tubular section 8, preferably made of quartz glass, and they are separated from the volume of the rectangular wave guide 1 such that process gas introduced into the hollow tube section 3′ cannot penetrate into the rectangular wave guide 1. A seal is established by sealing gaskets 9. Within the hollow tube 3, 3′ there is provided an electrically conductive internal conductor 10 which terminates at the stepped enlargement 4 of the diameter of the hollow tube 3. Preferably, the end of the internal conductor 10 is pointed. Within the cavity formed by the enlargement 4 of the diameter of the hollow tube 3 there is provided, in accordance with the invention, a single-layered cylindrical coil 12 provided with a plurality of windings separated from each other by space a. The potential of the cylindrical coil 12 is separated from that of the hollow metallic tube 3. As regards its internal diameter D3, the cylindrical coil 12 is dimensioned to circumscribe the plasma 5 without coming into contact with it. In a plasma burner constructed for a microwave frequency of 2.45 GHz, the diameter D1 of the hollow tube 3 or of the hollow tube section 3′ is about 50 mm, the diameter D2 of the diameter enlargement 4 is about 85 mm and the internal diameter D3 of the single-layered cylindrical coil 12 is about 55 mm. The cross-sectional diameter of the conductive material used for the cylindrical coil 12 is about 6 mm, and the spacing between the windings is about 20 mm.

For operating the plasma burner, microwaves are guided to the hollow tube 3 and, further, over the coaxial guide system consisting of the hollow tube 3 and the internal conductor 10 to the area of the stepped enlargement 4 of the diameter or, that is, to the end of the internal conductor 10 structured with a point 11. At the same time, process gas is fed by way of the gas feed connections 7 which flows through the hollow tube 3, 3′ to the point 11 of the internal conductor 10. The intensity of the turbulence is reduced during flow through the hollow tube 3, 3′. As a consequence of the increased electrical field strength at the point 11 of the internal conductor 10, a plasma 5 will ignite and, with the flowing process gas, will extend into the cavity formed by the enlargement 4 of the diameter. The plasma 5, the section 4 of enlarged diameter of the hollow tube and the cylindrical coil 12 arranged in accordance with the invention establish a waveguide system which in respect of the impedance and transmission band width parameters is especially well suited for propagating the microwaves in this area of the plasma burner. The electrical interaction between, on the one hand, the coaxial external conductor made up of the cylindrical coil 12 and the diameter enlargement 4 of the hollow tube 3 and, on the other hand, the coaxial internal conductor made up of the plasma 5, brings about a sufficient propagation of the microwaves even at changing conditions of pressure of the process gas, i.e. changing electrical properties of the plasma 5. In this manner, a stable plasma 5 and an assured ignition or re-ignition of this plasma 5 are attained. In this connection, the impedance of the waveguide system may be adjusted to different operating conditions by means of the short circuit 6.

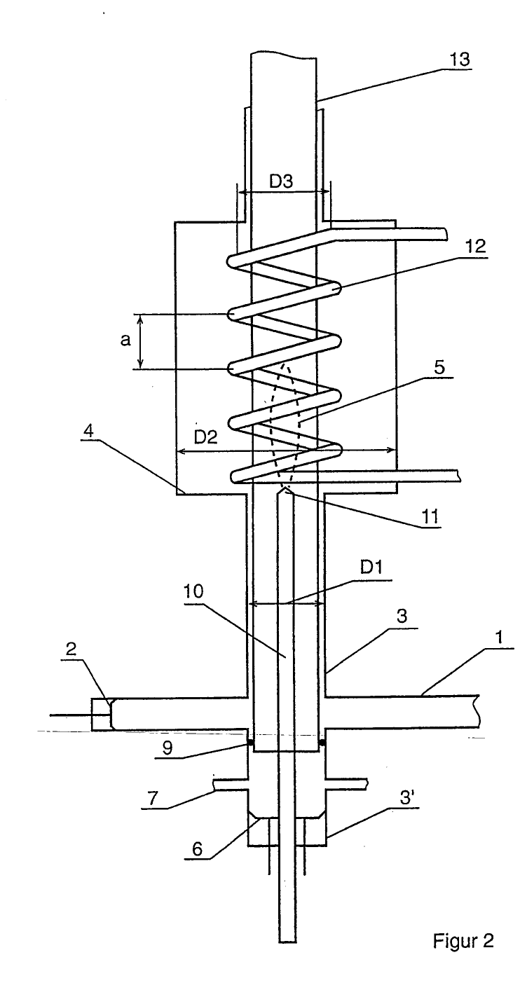

FIG. 2 depicts the described plasma burner modified by the arrangement of a non-conductive tube 13, preferably made of quartz glass, in the hollow tube 3, 3′, and by the cylindrical coil 12 being structured for cooling and as electrically connected to the diameter enlargement 4 of the hollow tube 3. A shown in FIG. 2, the non-conductive tube 13 is arranged such that it feeds the process gas introduced by way of the gas feed connections 7 within the plasma burner. Where necessary, the gas feed may, of course, extend beyond the plasma burner. This is important in those application where the process gas contains substances or where substances are formed during the process which must not escape into the environment. Cooling of the cylindrical coil 12 is advantageous where the plasma burner is operating continuously.

What is claimed is:

1-5. Cancelled

6. A plasma burner with microwave stimulation, comprising:
a waveguide of a hollow interior for feeding microwaves;
a hollow metallic tube comprising a first elongated section having an interior of a first internal diameter and branching off the waveguide and a second section of a second internal diameter larger than and joined with the first diameter by an annular shoulder for forming a cavity of a length not less than a plasma formed therein;
an internal conductor coaxially arranged within the hollow metallic tube and having a first end near the waveguide and a second end near the shoulder;
non-conductive sealing means for forming a chamber in the hollow metallic tube separated from the interior of the waveguide;
means for feeding a process gas into the chamber;
a plurality of axially separated electrically connected conductive windings coaxially arranged in the cavity and having an external diameter less than the second diameter and an internal diameter larger than the diameter of the plasma.

7. The plasma burner of claim 6, wherein the windings form a single-layered cylindrical coil extending along the length of the cavity.

8. The plasma burner of claim 6, further comprising means for insulating the windings from the hollow tube.

9. The plasma burner of claim 6, wherein the windings are provided with coolant conductive means.

10. The plasma burner of claim 9, wherein the windings are made of tubular wire.

11. The plasma burner of claim 6, wherein the means for feeding the process gas to the chamber are configured to provide process gas of low intensity turbulence at the second end of the internal conductor.
